(19) United States
(12) Patent Application Publication
(10) Pub. No.: US 2015/0067228 A1
(43) Pub. Date: Mar. 5, 2015

(54) UNIVERSAL SERIAL BUS DEVICE

(71) Applicant: COMBO STUDIO LIMITED, Tsuen Wan (HK)

(72) Inventor: Ka Ying CHAN, Tsuen Wan (HK)

(21) Appl. No.: 14/478,741

(22) Filed: Sep. 5, 2014

(30) Foreign Application Priority Data
Sep. 5, 2013 (CN) 201310400699.6

(51) Int. Cl. G06F 13/40; G06F 13/38

(52) U.S. Cl. CPC G06F 13/4022; G06F 13/409; G06F 13/385
USPC 710/316

(57) ABSTRACT

The present invention relates to the field of electronic communications, which discloses a Universal Serial Bus device comprising an OTG controller used for connecting two external devices for data exchange; a first plug used for insertion of the first external device; a second plug used for insertion of the second external device; and the OTG controller that connects with the first plug and the second plug; wherein the Universal Serial Bus device also comprises a switching device that is used for controlling the connection of the first plug and the second plug, and performing data processing through the OTG controller. By changing the operating state of the switching device, data connection between mobile devices, connection between the computer and mobile device, using as a power supply line for charging mobile devices or batteries can be achieved, thereby increasing the versatility and portability of the Universal Serial Bus device.

### TECHNICAL FIELD OF THE INVENTION

The present invention relates to the field of electronic communications, and more particularly, to a multi-functional Universal Serial Bus device.

### BACKGROUND OF THE INVENTION

Universal Serial Bus (referred to as USB) was a data transmission bus originally advocated by Intel, Microsoft, Compad, IBM, NEC and several other major vendors. As its biggest feature is the ability to support Hot-plug and Plug & Play“, the usage of USB is far more convenient than the PCI bus and the ISA bus. According to the standard definition of USB, the USB devices are divided into a USB host and USB slave. USB hosts include examples such as personal computers, whereas USB slaves include examples such as hard drives, personal digital assistants, digital cameras, printers, USB flash drives, and so on. Data transmission can only be realized when a USB host is connected to a USB slave. In illustrating such a model, the personal computer would be regarded as the Host device, while other device/s connected to that particular computer would be regarded as the slave/s.

The development of USB technology has enabled personal computers and peripheral devices to connect with devices having various data transfer speed through simple methods and modest manufacturing costs. The aforementioned applications are connected to personal computers via USB, with the data exchange done through the control of personal computers. However, as there is no device that can serve as a host like a personal computer (Host), once the personal computers are not used, this t convenient exchange among various devices will be unable to operate through the USB port.

The goal of OTG (USB On-The-Go) controller is to enable data transfer among devices in the absence of a Host. For example, by connecting two devices at the USB port through an OTG controller, a digital camera can be directly connected to the printer, and the captured images can instantly be printed as photos. Likewise, the data in the digital camera can also be sent to the flash drive at the USB port or SD cards through the OTG controller. Hence, bringing a portable computer for field or outdoor operation will no longer be necessary.

Apart from transferring data from the Host, regular USBs also possess a function of charging the portable devices through the Host or external power supply. In comparison, the USB with OTG controller cannot function as power cords. When a portable device needs to be recharged from an external power supply, the USB cannot be used for recharging. Rather, it would be necessary to replace the power cord, which complicates the operation.

### SUMMARY OF THE INVENTION

The object of the present invention is to solve the technical defects that USBs with OTG controller cannot be used as charging cords, providing a USB device with both the roles of a charging cord and OTG functionality. The technical solution of the present invention is as follows: a Universal Serial Bus device, comprising

an OTG controller used for connecting two external devices for data exchange;
a first plug used for insertion of the first external device;
a second plug used for insertion of the second external device, in which the OTG controller that connects with the first plug and the second plug;
wherein the Universal Serial Bus device also comprises a switching device that is used for controlling the connection of the first plug and the second plug, and performing data processing through the OTG controller.

In this invention, the term “plug” refers to the various connection ports that connect two devices. For instance, in one embodiment, the first plug can be a UBS port, and the second plug can be an SD card reader. In another embodiment, the first plug can be an SD card reader, whereas the second plug can be an UBS port.

According to one embodiment of the invention, the OTG controller is connected with the first plug and the second plug through a first data cable and a second data cable respectively; a socket used for tight connection with the first plug and the second plug in a snap-in manner is mounted on the OTG controller, and wherein the socket comprises an insertion slot and a sealing gasket. Preferably, the socket comprises an extension arm, and engaging holes for fastening with the extension are provided on the first plug and second plug, in order to further improve the insertion seal.

Preferably, the fastening structure is a zip-fastening structure, allowing the two cables to fasten or detach from each other. The fastening structure comprises a plurality of engaging portions located on the first data cable and the second data cable, and a plurality of occluders located on the first data cable and the second data cable, which are capable of engaging or detaching the engaging portions.

Preferably, the switching devices is disposed on a matching area of the first plug and the second plug, where is on one side of the projection on the first plug; and a waterproof pad is provided on peripheral edge of the switching device, in which the waterproof pad can be tightly sealed on the matching area of one side of a groove of the second plug. The waterproof pad can tightly seal the matching surface of the groove on the second plug.

Through switching the operating state of the switching devices of this invention, data connection between mobile devices, connection between the computer and mobile devices, or charging mobile devices or batteries can be achieved, thereby increasing the versatility and portability of the Universal Serial Bus device. The snap-in structure between the first plug, the second plug and the sockets can prevent short circuit of the first plug and the second plug due to water. The projections of the first plug and the second plug and the embedded groove structure can ensure the same level of the first plug and the second plug, which further improves the water-proof property at the insertion part. Fastening of the first data cable and the second data cable is a connection of convenient structure as well as the storage of the entire device. The switching device on the matching surface of the first plug can prevent short circuit of the switching device due to water.

### BRIEF DESCRIPTION OF THE DRAWINGS

The features of the present invention may be clearly set forth with reference to the accompanying drawings. The invention, together with the advantages thereof may be best understood by reference to the following description taken in conjunction with the accompany drawings, wherein like reference signs identify like elements, and wherein:

FIG. 1 is a perspective view of a Universal Serial Bus device;

FIG. 2 a schematic view of FIG. 1 in direction A;

FIG. 3 is a perspective view of one end of controller of a Universal Serial Bus Device;

FIG. 4 is a perspective view of the first plug; and

FIG. 5 is a perspective view of the second plug.

### DETAILED DESCRIPTION OF THE INVENTION

The structure of the device of the invention will be explained in detail with reference to the accompany drawings. The description and explanatory embodiment herein are merely used to set forth the present invention, not to limit the invention.

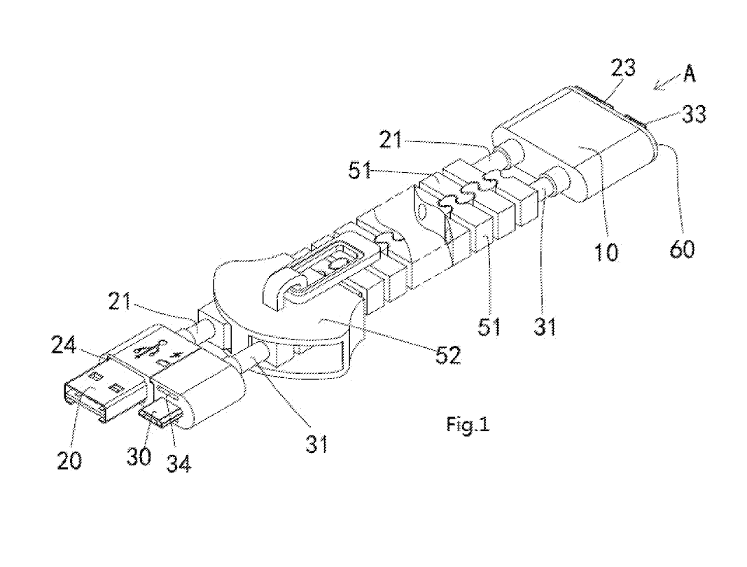

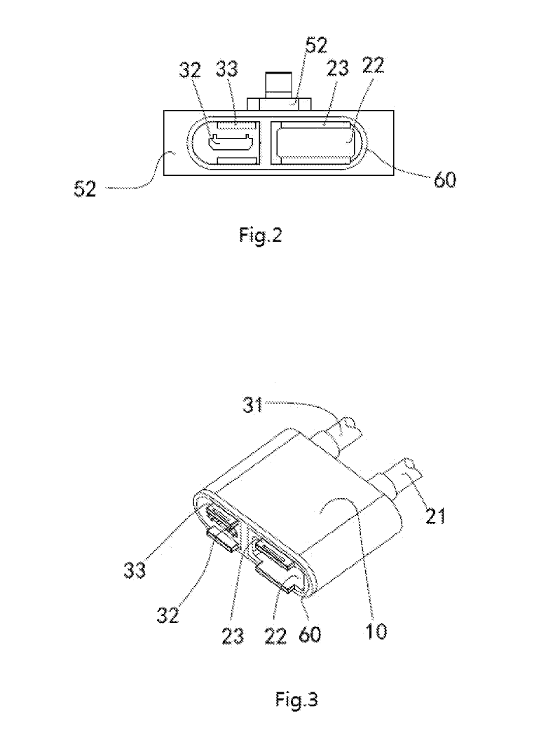

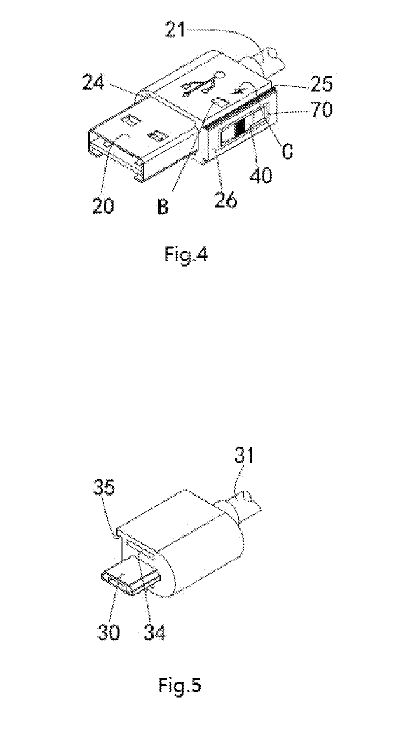

As shown in FIG. 1 to FIG. 5, a Universal Serial Bus device is disclosed in thin invention. The device includes an OTG controller 10 used for connecting two external devices for data exchange; a first plug 20 for insertion to the first external connection device, a second plug 30 for insertion to the second external connection device. The OTG controller 10 connects with the first plug 20 and the second plug 30 respectively. Through the connection with the first plug 20 and the second plug 30, it connects with the first external device and the second external device. In addition, the device also includes a switching device 40, which controls and checks if the connection between the first plug 20 and the second plug 30 has passed the data processing through the OTG controller 10. The switching device 40 has two operating states. In the first state, the connection with OTG controller in the Universal Serial Bus device has OTG functions, which can enable data transmission between devices even in the absence of a Host. In the second state, the OTG controller does not process the data in the connection between the first plug 20 and the second plug 30. The Universal Serial Bus device is an extension cable for normal Universal Serial Bus, which can enable the connection and data transmission between the Host and mobile device (or memory flash) in the presence of a Host. It can also serve as a power supply line that performs charging for the batteries of mobile devices through the host or supply of electricity. In order to improve the connectivity of the device with a corresponding device, the first plug 20 and the second plug 30 in this embodiment are connected to OTG controller 10 through the first data cable 21 and the second data cable 31 respectively. The flexible first data cable 21 and the second data cable 31 allows the first plug 20 and the second plug 30 to more conveniently connect to the corresponding devices.

In order to facilitate the storage of the device, the first data cable 21 and the second data cable 31 are arranged in a parallel and can be fastened together. When not in use, the first data cable 21 and the second data cable 31 of this device can be fastened to give an appearance of a single cable, with the length reduced by half and the easy storage. When using the device, the first data cable 21 and the second data 31 are released, which allows the first data cable 21 to detach from the second data cable 31. This device is enough long, which enables the connection with corresponding devices. The fastening of the first data cable 21 and the second data cable 31 can either be done through zip-fastening or by means of using the fastening groove on the first data cable 21 and embedding the second data cable 31 into the fastening groove of the second data cable.

In one embodiment of the invention, the zip-fastening is utilized. Specifically, a plurality of engaging portions 51 are arranged in the first data cable 21 and the second data cable 31. The engaging portions 51 can be engaged and detached each other by the occluder 52 on the first data cable 21 and the second data cable 31.

The superior portability of the invention allows this device to be used in different environments, especially for outdoor usage during travels and business trips. When using in outdoor circumstances, the first plug 20 and the second plug 30 can easily encounter short circuit due to water. This device of the invention is provided with a waterproof structure: a socket for snapping-in the first plug 20 and the second plug 30 is provided on the OTG controller 10. The sockets include the insertion slots 22, 32, and the gasket 60. The first plug 20 and the second plug 30 are inserted in the insertion slots 22 and 32, while the gasket 60 provides a seal from the outside. Two extension arms 23 and 33, installed at the upper and lower parts of the insertion slots 22 and 32 respectively, can be fastened in the fastening holes 24 and 34 of the first socket 20 and the second socket 30, which can further improve the insertion stability. A projection 25 and a sliding chute 35 are arranged on the first plug 20 and the second plug 30 respectively. The projection 25 can be inserted into the sliding chute 35 in order to match and secure the first plug 20 and the second plug 30. Use of the snap-in structure can ensure better sealing after the first plug 20 and the second plug 30 are inserted into the insertion slots 22 and 32. Preferably, the switching device 40 is placed on a matching area 26 of the first plug and the second plug. Meanwhile, the peripheral edge of the switching device 40 is covered by a waterproof pad 70. When the projection 25 is inserted into the sliding chute 35, the matching area of the second plug will seal the switching device in order to seal the switching device 40. The following examples illustrate the use of this device. A: Data Connection between Smart Phone and USB flash memory—moving the occluder 52 to one end of the OTG controller 10 in order to separate the first data cable 21 from the data data cable 31 and allowing the first plug 20 and the second plug 30 to slide while facing each other; Detaching the projection 25 from the groove 35 so that the first plug 20 is separated from the second plug 30; meanwhile switching the switching device 40 to Position B that bears the icon of SD card and connecting the first plug 20 with the USB flash memory. By connecting the second plug 30 to the insertion port of the smart phone, the data interchange between the smart phone and the USB can be achieved.

B: Data Connection Between Notebook and Smart Phone: Moving the occluder 52 to one end of the OTG controller 10 in order to separate the first data cable 21 from the second data cable 31 and allowing the first plug 20 and the second plug 30 to slide while facing each other; Detaching the projection 25 from the groove 35 so that the first plug 20 is separated from the second plug 30; Meanwhile switching the switching device 40 to Position C that bears the icon of flash and connecting the first plug 20 with the insertion port on the smart phone. By connecting the second plug 30 to the insertion port of the smart phone, the data interchange between the notebook computer and smart phone can be achieved.

C: As Power Cord for Charging the Smart Phone: Moving the occluder 52 to one end of the OTG controller 10 in order to separate the first data cable 21 from the second data cable 31 and allowing the first plug 20 and the second plug 30 to slide while facing each other; Detaching the projection 25 from the groove 35 so that the first plug 20 is separated from the second plug 30; Meanwhile switching the switching device 40 to Position C that bears the icon of flash and connecting the first plug 20 with the insertion port for power. By connecting the second plug 30 to the insertion port of the smart phone, power charging for the smart phone can be achieved.

D: Storage of the Device—sliding the first plug 20 and the second plug 30 while making the plugs face each other; and embedding the projection 25 onto the groove 35 in order to fasten the first plug 20 with the second plug 30; sliding the occluder 52 to the end, where the first plug 20 is fastened with the second plug 30, in order to allow the first data cable 21 to join with the second data cable 31 and form into one line; Finally, snapping the first plug 20 and the second plug 30 into the sockets 22 and 32.

While a particular embodiment of the invention has been shown and described, it will be obvious to those skilled in the art that changes and modifications can be made without departing from the true spirit and scope of the invention. It should be understood that the embodiments of the present invention described above are illustrative only, and all the changes and modifications made by those skilled in the art are covered by the appended claims.

What is claimed is:

1. An Universal Serial Bus device, comprising
an OTG controller used for connecting two external devices for data exchange;
a first plug used for insertion of the first external device;
a second plug used for insertion of the second external device, in which the OTG controller is connected with the first plug and the second plug;
wherein the Universal Serial Bus device also comprises a switching device that is used for controlling the connection of the first plug and the second plug, and performing data processing through the OTG controller.

2. The Universal Serial Bus device according to claim 1, wherein the OTG controller is connected with the first plug and the second plug through a first data cable and a second data cable respectively; and a socket used for tight connection with the first plug and the second plug in a snap-in manner is mounted on the OTG controller, and wherein the socket comprises an insertion slot and a sealing gasket.

3. The Universal Serial Bus device according to claim 1, wherein the socket comprises an extension arm, and engaging holes for fastening with the extension arm are provided on the first plug and second plug.

4. The Universal Serial Bus device according to claim 2, wherein the first data cable and the second data cable can be engaged to form one cable by a fastening structure, in which the first data cable can be fastened or detached from the second data cable.

5. The Universal Serial Bus device according to claim 4, wherein the fastening structure is a zip-fastening structure, which structure comprises a plurality of engaging portions located on the first data cable and the second data cable and a plurality of occluders located on the first data cable and the second data cable which are capable of engaging or detaching the engaging portions.

6. The Universal Serial Bus device according to claim 2, wherein a projection is provided on the first plug, and a sliding chute is provided on the second plug for sliding the projection embedded thereon.

7. The Universal Serial Bus device according to claim 6, wherein the switching devices is disposed on a matching area of the first plug and the second plug, where is one side of the projection on the first plug; and a waterproof pad is provided on peripheral edge of the switching device, in which the waterproof pad can be tightly sealed on the matching area of one side of a groove of the second plug.
